(19) United States
(12) Patent Application Publication
(10) Pub. No.: US 2023/0000159 A1
(43) Pub. Date: Jan. 5, 2023

(54) Aerosol Generating Device With Porous Convection Heater

(71) Applicant: JT International S.A., Geneva (CH)

(72) Inventor: Alec Wright, Guildford (GB)

(73) Assignee: JT International SA, Geneva (CH)

(21) Appl. No.: 17/781,957

(22) PCT Filed: Dec. 1, 2020
(86) PCT No.: PCT/EP2020/084090

§ 371 Date: Jun. 2, 2022

(30) Foreign Application Priority Data
Dec. 2, 2019 (EP) 19212923.7

(51) Int. Cl. A24F 40/46; A24F 40/50

(52) U.S. Cl. CPC A24F 40/46; A24F 40/50

(57) ABSTRACT

The invention is generally directed to aerosol generating devices. In particular, the invention is directed to aerosol generating devices comprising a convection heating element. According to a first aspect, the invention provides an aerosol generating device, comprising a chamber configured to at least partially receive an aerosol generating substrate, an air flow path extending through the chamber, a convection heater positioned upstream of the chamber in a flow direction through the flow path, and a heating element comprising a porous structure, configured such that air that is to flow through the flow path is caused to pass the heating element to reach the chamber.

### TECHNICAL FIELD

The invention is generally directed to aerosol generating devices. In particular, the invention is directed to aerosol generating devices comprising a convection heating element.

### BACKGROUND

Aerosol generating devices commonly employ convection heaters which heat air that is used to heat an aerosol generating substrate to generate an aerosol or vapor. However, current convection heater configurations have several drawbacks. If the convection heater is configured as a heating plate, the heating plate only affords a small contact surface for air to be heated and thus results in an inhomogeneous and weak heating performance. Other configurations employ a heating element combined with a heat diffuser which either distributes the heat generated by the heating element or diffuses the air heated by the heater to achieve a more homogeneous heating of an aerosol generating substrate. It further can serve the purpose of assisting in allowing the heating element itself to heat up in a more homogeneous manner, to possibly avoid thermal runaways. However, since the heat diffuser is not an active heating element, heating performance is lacking.

Therefore, it is an objective of the present disclosure to provide a convection heater which affords improved heating performance and/or more homogeneous heating of the heater.

### SUMMARY OF THE INVENTION

The above objective is achieved by the invention as defined by the features of the independent claims. Advantageous preferred embodiments thereof are defined by the features of the dependent claims.

According to a first aspect, the invention provides an aerosol generating device, comprising a chamber configured to at least partially receive an aerosol generating substrate, an air flow path extending through the chamber, a convection heater positioned upstream of the chamber in a flow direction through the air flow path, and a heating element comprising a porous structure, configured such that air that is to flow through the air flow path is caused to pass the heating element to reach the chamber. The porous structure of the heating element provides a higher heating surface to volume ratio in contrast to a heating element in the shape of a plate or rod. This allows air passing through the porous structure to be effectively and uniformly heated.

In a first preferred embodiment according to the first aspect of the invention, the heating element consists of or comprises a sintered metallic material. Using a sintered metallic material is advantageous because the sintering process already affords a porous structure without the need for machining steps when, for example, attempting to create a porous structure from a solid piece of metallic material.

In a second preferred embodiment according to any one of the preceding embodiments of the invention, the heating element comprises a metallic material having a low temperature coefficient of resistance α. Having a lower temperature coefficient of resistance means that even when the metallic material heats up, the electric resistance of the metallic materials is barely changed. This is advantageous because it suppresses occurrence of hot spots in the heating elements, and thus reduces the probability of a thermal runaway that could result in catastrophic failure of the heater and/or heating damage to the aerosol generating device and potentially to a user of the aerosol generating device.

In a third preferred embodiment according to any one of the preceding embodiments of the invention, the temperature coefficient of resistance α is between 0.0000 and 0.001, preferably between 0.0000 and 0.0009, more preferably between 0.0000 and 0.0008, even more preferably between 0.0000 and 0.0007, even more preferably between 0.0000 and 0.0006, even more preferably between 0.0000 and 0.0005, even more preferably between 0.0000 and 0.0004, even more preferably between 0.0000 and 0.0003, even more preferably between 0.0000 and 0.00025, even more preferably between 0.0000 and 0.0002, even more preferably between 0.0000 and 0.00015.

In a fourth preferred embodiment according to any one of the first to third preferred embodiments of the invention, the metallic material comprises stainless steel, NiCr, CuNi, NiCrAl and/or SiCrN, preferably NiCr.

In a fifth preferred embodiment according to any one of the preceding embodiments of the invention, the aerosol generating device comprises a conduction heater component configured to heat at least parts of the aerosol generating substrate. By having an additional conduction heater, the aerosol generating device is capable of generating aerosol from aerosol generating substrates that require or prefer conduction heating such as, for example, tobacco based aerosol generating substrates.

In a sixth preferred embodiment according to any one of the preceding embodiments of the invention, the heating element is provided with a first electrode that is a bias plate and a second electrode that is a grounding plate. By providing a bias contact and grounding contact in the shape of a plate, a more uniform heating of the heating element may be achieved due to a more spatially homogeneous current flow through the heating element. As an example, voltage larger than 3 V, preferably larger than 4 V, more preferably larger than 5 V, most preferably larger than 6 V may be applied to the bias plate.

In a seventh preferred embodiment according to the sixth preferred embodiment of the invention, the heating element is disposed between the bias plate and the grounding plate. This further affords a more homogeneous heating of the heating element due to a more homogenous electric field due of such an arrangement.

In an eighth preferred embodiment according to any one of the sixth to the seventh preferred embodiments of the invention, at least one of the bias plate and the grounding plate comprises pores configured to allow air to flow through the bias plate and/or grounding plate. By providing pores in the bias plate and/or the grounding plate, air may pass through the heating element from sides where the bias plate and/or the grounding plates are provided, thus increasing the air flow rate through the heating element.

In a ninth preferred embodiment according to the preceding embodiments, the porosity of the bias plate and/or the grounding plate is larger than the porosity of the porous structure of the heating element, and in a tenth preferred embodiment according to any one of the eighth or ninth preferred embodiments of the invention, the average pore size of the bias plate and/or the grounding plate is larger than the average pore size of the porous structure of the heating element. These two embodiments are advantageous because they allow the heating element to be the rate limiting factor for the air flow rate through the heating element and not the bias plate and/or the grounding plate, thus ensuring an ample supply of air to pass through the heating element.

In an eleventh preferred embodiment according to any one of the seventh to tenth preferred embodiments of the invention, the bias plate is provided with a bias connection arranged substantially in the center of the bias plate.

In a twelfth preferred embodiment according to any one of the seventh to eleventh preferred embodiments of the invention, the grounding plate is provided with one or more grounding connections that ground the grounding plate, wherein the one or more grounding connections are arranged at one or more positions along the circumference of the grounding plate. The grounding connections may assist in providing an improved or steadier ground connection for the grounding plate.

In a thirteenth preferred embodiment according to the fourteenth embodiment, the grounding plate is provided with one or more ballast resistors arranged at positions corresponding to the one or more grounding connections. Ballast resistors provided with the grounding connections improve the reliability and longevity of the heating element as the ballast resistors balance out current differences at each grounding connection and thus ensure a more homogenous spatial current flow through the heating element and thus a more homogenous spatial heating of the heating element.

In a fourteenth preferred embodiment according to any of the preceding embodiments of the invention, the porous structure is a microporous structure.

In a fifteenth preferred embodiment according to the fourteenth preferred embodiment of the invention, the average pore size of the porous structure of the heating element is in the range of 0.025 mm±0.02 mm, preferably 0.025 mm±0.01 mm, more preferably 0.025 mm ±0.005 mm, most preferably 0.025 mm±0.0025 mm.

In a sixteenth preferred embodiment according to any one of the tenth to thirteenth preferred embodiments of the invention, the average pore size of the grounding plate and/or the bias plate is between 100-400 μm, preferably between 150-350 μm, more preferably between 175-325 μm, even more preferably between 200-300 μm, even more preferably between 225-275 μm, and most preferably between 240-260 μm.

### BRIEF DESCRIPTION OF THE DRAWINGS

FIG. 1 illustrates a schematic cross-section of an aerosol generating device with a convection heater according to embodiments of the invention;

FIG. 2A illustrates a schematic perspective view of a convection heater according to embodiments of the invention;

FIG. 2B, 2C and 2D illustrate schematic top views of a bias plate, a grounding plate and a heating element, respectively, according to embodiments of the invention.

### DETAILED DESCRIPTION

Preferred embodiments of the present invention are described herein after and in conjunction with the accompanying drawings.

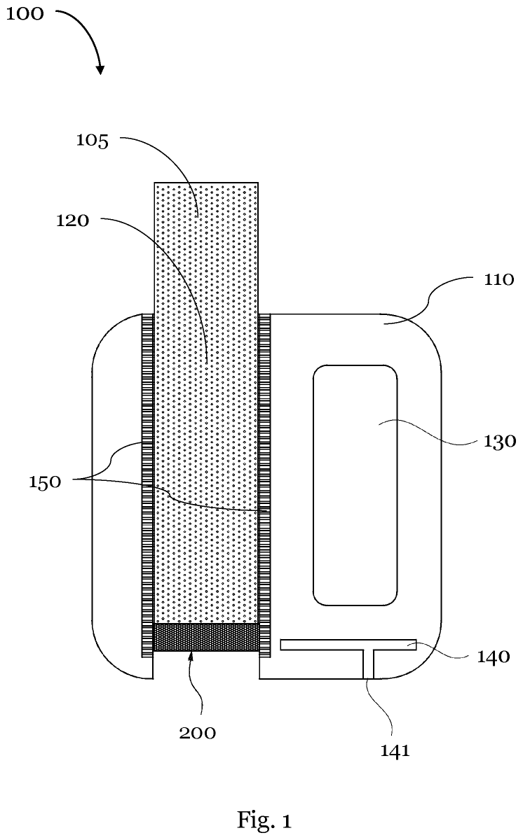

As illustrated in FIG. 1, an aerosol generating device 100 may comprise a housing 110. The housing 110 is configured such that it may accommodate a chamber 120 that is capable of at least partially receiving an aerosol generating substrate 105 for generating an aerosol in the chamber 120. The chamber 120 may be open to one side of the aerosol generating device 100 such that the aerosol generating substrate 105 may be at least partially inserted into the chamber 120. The aerosol generating substrate 105 may be any substrate suitable for an aerosol based on an e-vapor or t-vapor. The aerosol generating substrate 105 may include a tobacco material in various forms such as shredded tobacco and granulated tobacco, and/or the tobacco material may include tobacco leaf and/or reconstituted tobacco if it is suitable for a t-vapor.

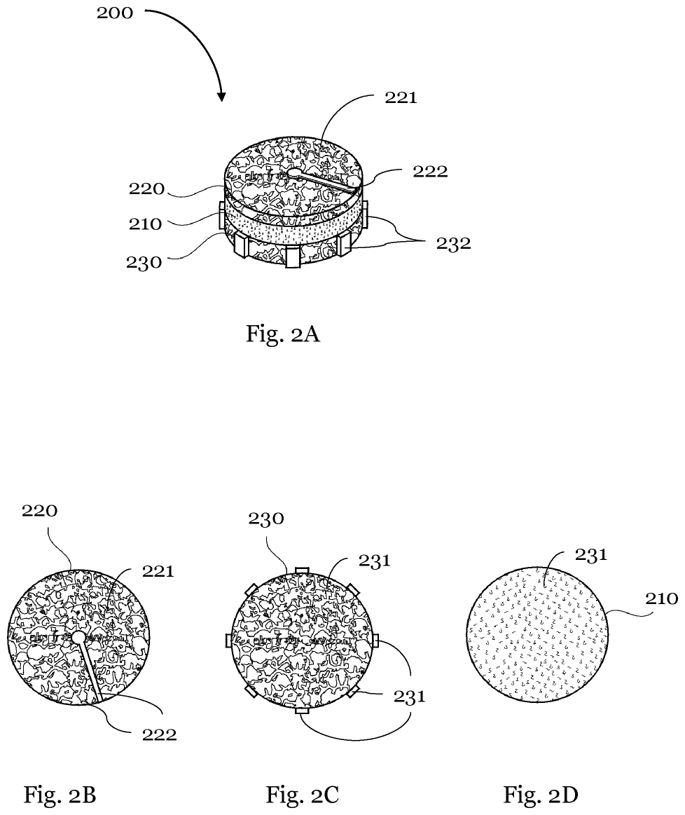

The aerosol generating device 100 comprises a convection heater 200 which is positioned upstream of the airflow path extending through the chamber 120. The air flow path may be, for example, achieved by an opening opposite the side of the housing 110 on which the opening for at least partially receiving an aerosol generating substrate 105 may be received. Additionally, or alternatively, while not shown in the drawings, an air flow path may also be realized by one or more air flow channels provided in the housing that extend from an inlet opening opened towards an outside of the aerosol generating device 100 at any suitable position, to an outlet opening positioned upstream of the convection heater 200 such that at least a part of the air exiting the outlet opening passes the convection heater 200. The convection heater 200 may be a convection heater as described below in the context of FIGS. 2A, 2B, 2C and 2D. Additionally, a conduction heater 150 may be provided such that an aerosol generating substrate at least partially received in the chamber 120 is heated by conduction. This may be achieved by the conduction heater 150 such that the conduction heater 150 heats at least parts of the aerosol generating substrate directly. Additionally, or alternatively, the conduction heater may be provided such that the conduction heater 150 heats the wall of the chamber 120 so that the chamber wall heats at least parts of an aerosol generating substrate by conduction. The conduction heater 150 may be any type of heater that is suitable to heat the aerosol generating substrate directly or indirectly. For example, the conduction heater 150 may be a film heater comprising an electrically-conductive heating track for resistive heating, and one or more base layers including an insulating material. The insulating material may be a resin material such as polyimide, silicone and/or PEEK.

The aerosol generating device may further comprise a mobile power source 130 such as a battery, for supplying power to the aerosol generating device for generating an aerosol. Furthermore, control circuitry 140 may be provided for controlling any function for operating and/or controlling the aerosol generating device 100. A charging port 141 may be provided for allowing the mobile power source 130 to be charged by any suitable means. Additionally, or alternatively, the mobile power source 130 may be exchangeable/replaceable.

As illustrated in FIGS. 2A to 2D, the convection heater 200 comprises a heating element 210 with a porous structure. While the heating element 210 with a porous structure is shown to be substantially plate-shaped with a circular base shape, the heating element may be of any shape or form suitable for heating air passing through the heating element 210. Depending on the configuration and dimensions of the aerosol generating device 100 and/or the chamber 120, the heating element 210 may alternatively be, for example, rod-shaped, cube-shaped or ball-shaped. The heating element 210 with a porous structure 210 comprises a plurality of heating element pores 211 that allow air to pass through the heating element 210. The heating element 210 may consist of or comprise a sintered metallic material. The metallic material may be any metallic material with a low temperature of coefficient of resistance α. The coefficient of resistance α may be between 0.0000 and 0.001, preferably between 0.0000 and 0.0009, more preferably between 0.0000 and 0.0008, even more preferably between 0.0000 and 0.0007, even more preferably between 0.0000 and 0.0006, even more preferably between 0.0000 and 0.0005, even more preferably between 0.0000 and 0.0004, even more preferably between 0.0000 and 0.0003, even more preferably between 0.0000 and 0.00025, even more preferably between 0.0000 and 0.0002, most preferably between 0.0000 and 0.00015. The metallic material may comprise stainless steel, NiCr, CuNi, NiCrAl and/or SiCrN, preferably NiCr, or any metallic material with similar characteristics. The heating element pores 211 may be of substantially the same size and/or substantially of the same shape. The heating element pores 211 may each be of a different size and/or different shape. The average pore size of the porous structure of the heating element 210 may be in the range of 0.025 mm±0.02 mm, preferably 0.025 mm±0.01 mm, more preferably 0.025 mm±0.005 mm, most preferably 0.025 mm±0.0025 mm.

A bias plate 220 may be provided on a first side of the heating element 210, and a grounding plate 230 may be provided on a second side, opposite the first side of the heating element. While the bias plate 220 and the grounding plate 230 are shown to be substantially plate-shaped and to substantially cover all of a first or a second side of the heating element 210, they may be of any suitable shape and size and cover all or only part of a first and/or second side of the heating element 210. Furthermore, the bias plate may be provided on any side of the heating element 210 on which the grounding plate is not provided. As shown in FIG. 2A, the thickness of the bias plate 220 is smaller than the thickness of the heating element 210; preferably the thickness of the bias plate 220 is at most 80%, more preferably at most 70%, even more preferably at most 60%, and most preferably at most 50%, of the thickness of the heating element 210. This will minimise the chance of any air cooling before it reaches the tobacco article. The bias plate 220 and/or the grounding plate 230 may comprise a plurality of pores 221/231 configured to allow air to flow through the bias plate and/or grounding plate. Each of the bias plate pores 221 and/or the grounding plate pores 231 may be of substantially the same size and/or substantially of the same shape. Alternatively, each of the bias plate pores 221 and/or the grounding plate pores 231 may be of a different size and/or different shape. Additionally, the porous structure of the bias plate with regard to any one of size, shape and/or average size of the plurality of pores may be the same or different in comparison to the porous structure of the grounding plate.

The porosity of the bias plate 220 and/or the grounding plate 230 may be larger than the porosity of the porous structure of the heating element. Furthermore, the average pore size of the plurality of pores 221/231 of bias plate 220 and/or the grounding plate 230 may be larger than the average pore size of the porous structure of the heating element 210. Additionally, the bias plate may be contacted via a bias connection 222 arranged substantially in the center of the bias plate. The bias plate may also be contacted via one or more bias connections 222 at one or more positions.

The ground plate may be provided with one or more ground connections 232 that may be arranged at one or more positions along the outer circumference of the grounding plate 230 for achieving a ground connection. Additionally, one or more ballast resistors 232 may be provided at the grounding plate 230 at positions corresponding to the positions of the one or more grounding connections. While the one or more ground connections 232 and/or the one or more ballast resistors 232 are shown in FIG. 2A and 2C to be positioned at positions equidistant from each other along the outer circumference of the grounding plate 230, the one or more grounding connections 232 and/or the one or more ballast resistors 232 may be placed at any suitable position with any suitable distance between positions along the outer circumference of the grounding plate 230, for example if required due to geometric or constructional parameters of the heating element 210 and/or the chamber.

It should be noted that any one of the chamber 120, heater 200, heating element 210, bias plate 220, grounding plate 230 or any combination thereof may, instead of the circular base shown in FIGS. 2A to 2D, have any appropriately shaped base such as an elliptic, rectangular, polygonal, or irregularly shaped base-profile.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the scope of this disclosure, as defined by the independent and dependent claims.

### LIST OF REFERENCE SIGNS USED IN THE DRAWINGS

100: aerosol generating device
105: aerosol generating substrate
110: housing
120: chamber
130: power supply
140: PCB/control circuit
141: charging port
150: conduction heater
200: convection heater
210: heating element with a porous structure
211: heating element pores
220: bias plate
221: bias plate pore
222: bias connection
230: grounding plate
231: grounding plate pores
232: grounding connection/ballast resistor

1. An aerosol generating device, comprising:
a chamber configured to at least partially receive an aerosol generating substrate;
an air flow path extending through the chamber;
a convection heater positioned upstream of the chamber in a flow direction through the air flow path and comprising a heating element comprising a porous structure, configured such that air that is to flow through the air flow path is caused to pass the heating element to reach the chamber,
wherein the heating element comprises a sintered metallic material.

2. The aerosol generating device according to claim 1, wherein the temperature coefficient of resistance α of the metallic material is between 0.0000 and 0.001.

3. The aerosol generating device according to claim 1, wherein the metallic material comprises stainless steel, NiCr, CuNi, NiCrAl and/or SiCrN.

4. The aerosol generating device according to claim 1, comprising a conduction heater component configured to heat at least parts of the aerosol generating substrate.

5. The aerosol generating device according to claim 1, wherein the heating element is provided with a first electrode that is a bias plate and a second electrode that is a grounding plate.

6. The aerosol generating device according to claim 5, wherein the heating element is disposed between the bias plate and the grounding plate.

7. The aerosol generating device according to claim 5, wherein at least one of the bias plate and the grounding plate comprises pores configured to allow air to flow through the bias plate and/or the grounding plate.

8. The aerosol generating device according to claim 7, wherein a porosity of the bias plate and/or a porosity of the grounding plate is larger than a porosity of the porous structure of the heating element.

9. The aerosol generating device according to claim 7, wherein an average pore size of the bias plate and/or an average pore size of the grounding plate is larger than an average pore size of the porous structure of the heating element.

10. The aerosol generating device according to claim 5, wherein the bias plate is provided with a bias connection arranged substantially in a center of the bias plate.

11. The aerosol generating device according to claim 5, wherein the grounding plate is provided with one or more grounding connections that ground the grounding plate, wherein the one or more grounding connections are arranged at one or more positions along a circumference of the grounding plate.

12. The aerosol generating device according to claim 11, wherein the grounding plate is provided with one or more ballast resistors arranged at positions corresponding to the one or more grounding connections.

13. The aerosol generating device according to claims 1, wherein the porous structure is a microporous structure.

14. The aerosol generating device according to the preceding claim 13, wherein an average pore size of the porous structure of the heating element is in the range of 0.025 mm±0.02 mm.

15. The aerosol generating device according to claims 7, wherein an average pore size of the grounding plate and/or an average pore size of the bias plate is between 100-400 μm.

16. The aerosol generating device according to claim 2, wherein the temperature coefficient of resistance α of the metallic material is between 0.0000 and 0.00015.

17. The aerosol generating device according to claim 14, wherein the average pore size of the porous structure of the heating element is in the range of 0.025 mm±0.0025 mm.

18. The aerosol generating device according to claim 15, wherein the average pore size of the grounding plate and/or the average pore size of the bias plate is between 240-260 μm.
